(19) United States
(12) Patent Application Publication
(10) Pub. No.: US 2010/0041006 A1
(43) Pub. Date: Feb. 18, 2010

(54) INTERACTIVE INSTRUCTIONAL BOOK AND RELATED TOY SYSTEM

(76) Inventor: Polina Ulendeeva, Brooklyn, NY (US)

Correspondence Address: MEREDITH & KEYHANI, PLLC, 330 MADISON AVE., 6TH FLOOR, NEW YORK, NY, 10017, US

(21) Appl. No.: 12/193,316

(22) Filed: Aug. 18, 2008

(51) Int. Cl. G09B 23/30

(52) U.S. Cl. 434/272; 434/267

(57) ABSTRACT

An instructional toy, comprising: a doll having an outside portion and an inside portion, the inside portion removably containing at least one body part; a book having a related shape of the at least one body part being substantially the same size and shape as the at least one body part and indicia on at least one page of the book related to the at least one body part.

This application claims priority to design patent application Ser. No. 29320764 entitled “Educational Doll and Book” and filed Jul. 2, 2008 as a continuing application.

The present invention relates instructional tools and more specifically to interactive instructional toys and a related book for teaching children about human anatomy. It is very difficult for children to understand the human anatomy, particularly when traditional methods of teaching are uninteresting and difficult to understand. There are three ways in which most children will learn: audio, visual and kinesthetic. Any learning that combines the different ways a child can learn is generally more effective. Also, children can more easily visualize human body parts by way of three dimensional toys rather than reading from a book. The present invention combines these learning methods and provides a system for teaching children about the human body.

These and other features, aspects and advantages of the present invention will become better understood with reference to the following description and claims.

### SUMMARY OF THE INVENTION

The present invention relates generally to instructional toys.

According to one embodiment of the present invention, an instructional toy is provided, comprising: a doll having an outside portion and at least one inside portion, each at least one inside portion removably containing at least one body part; a book having a related shape of at least one body part being substantially the same size and shape as the at least one body part and indicia on at least one page of the book related to the at least one body part.

According to another embodiment of the present invention, an instructional toy is provided, comprising: a doll having an outside portion and at least one inside portion, at least one inside portion removably containing at least one body part; a book having at least one related shape of the at least one body part being substantially the same size and shape as the at least one body part and indicia on at least one page of the book related to the at least one body part, wherein at least one body pad is a first color and at least one related picture is the same first color.

These and other features aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

FIG. 9 depicts the present invention;

FIG. 10 depicts the present invention;

FIG. 11 depicts the present invention;

FIG. 12 depicts the present invention;

FIG. 13 depicts the present invention;

FIG. 14 depicts the present invention;

FIG. 15 depicts the present invention;

FIG. 16 depicts the present invention;

FIG. 17 depicts the present invention;

FIG. 18 depicts the present invention;

FIG. 19 depicts the present invention;

FIG. 20 depicts the present invention;

FIGS. 21A-21F depicts the present invention;

FIGS. 22A-22F depicts the present invention;

FIGS. 23A-23F depicts the present invention;

FIGS. 24A-24F depicts the present invention;

FIGS. 25A-25F depicts the present invention;

FIGS. 26A-26F depicts the present invention;

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

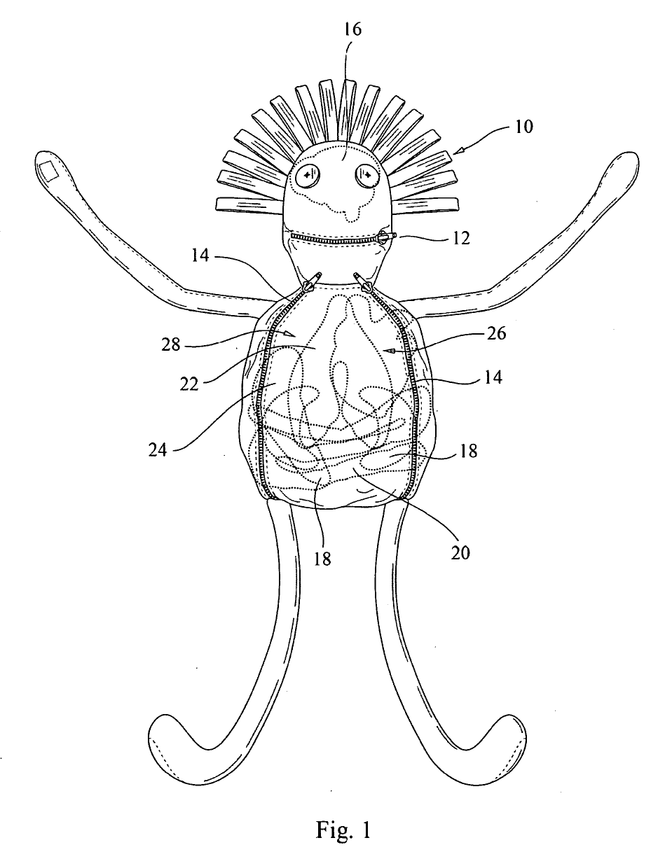

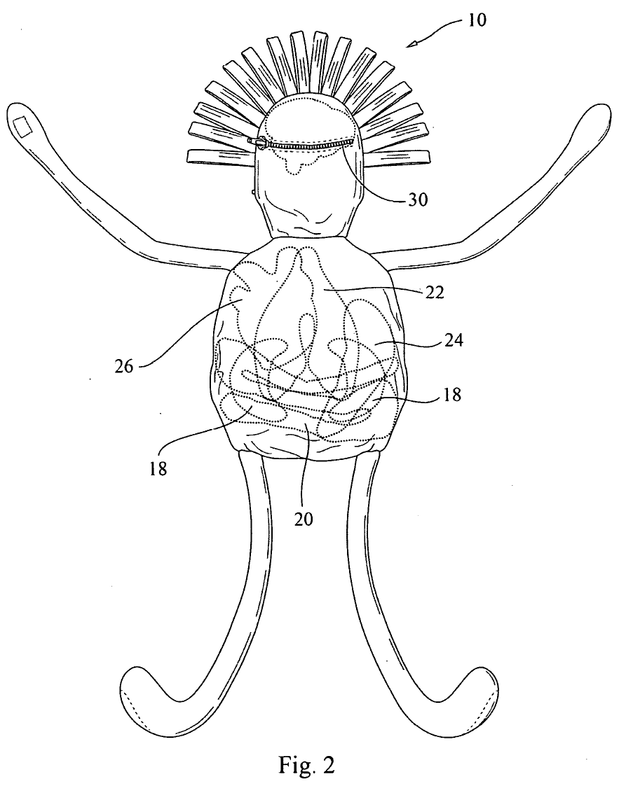

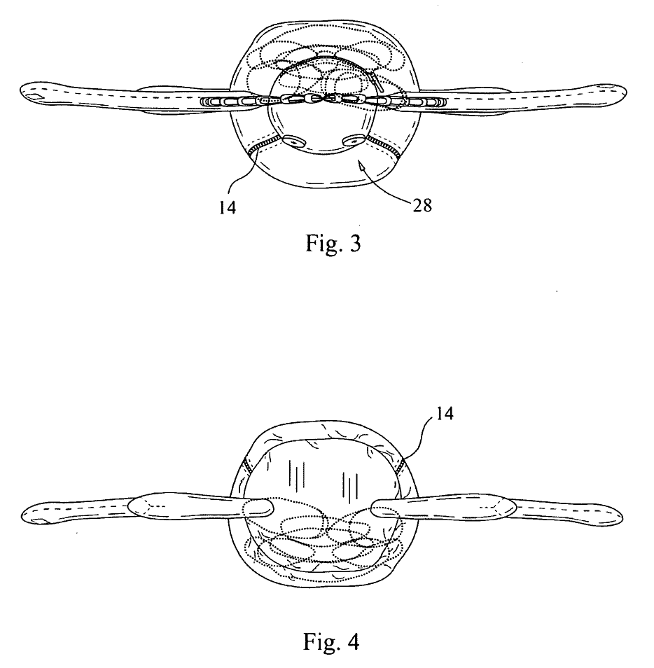

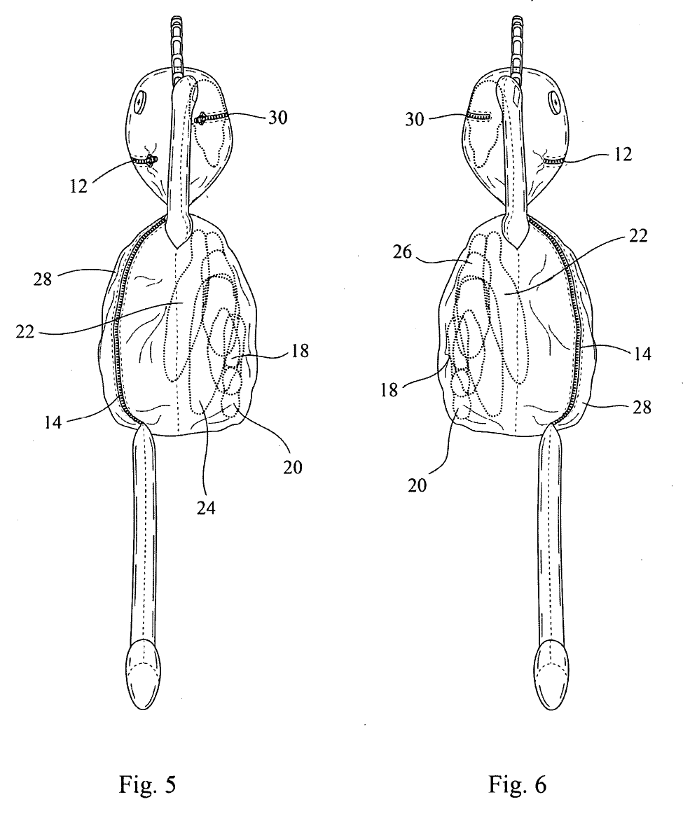

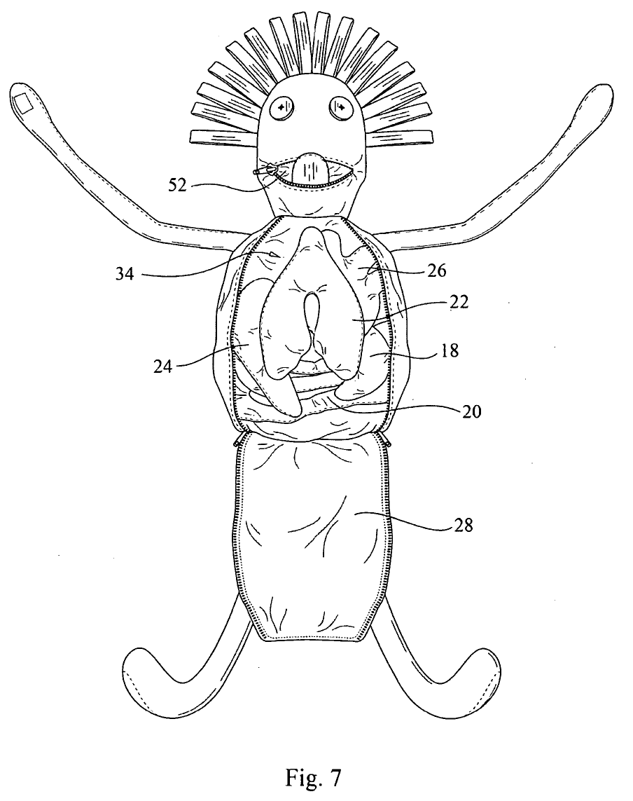

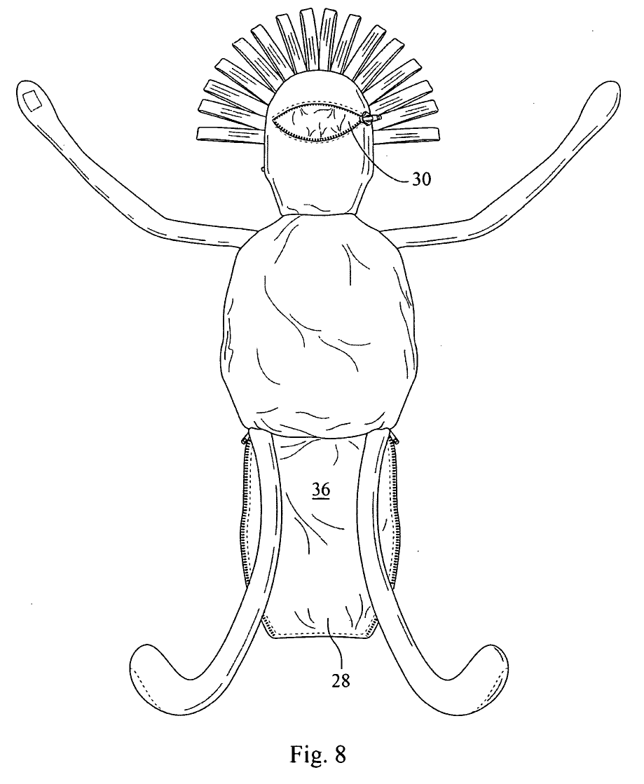

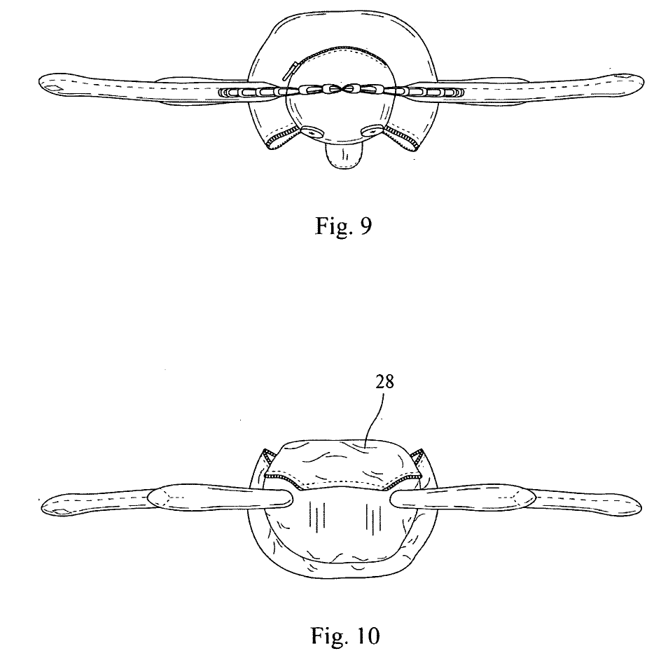

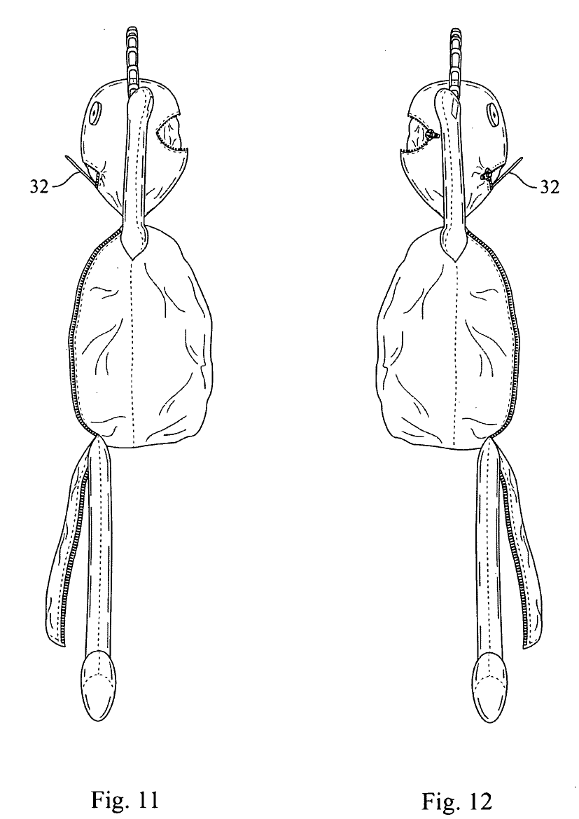

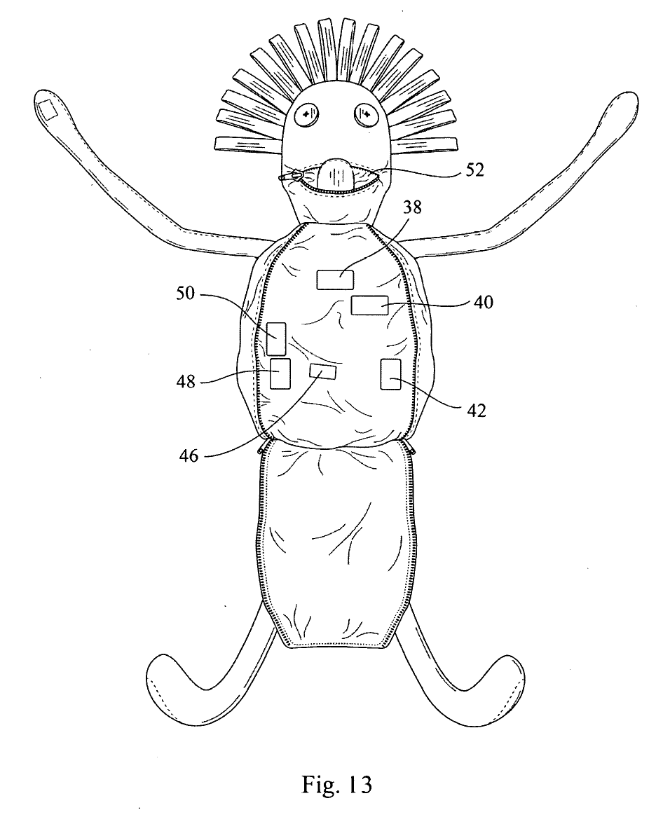

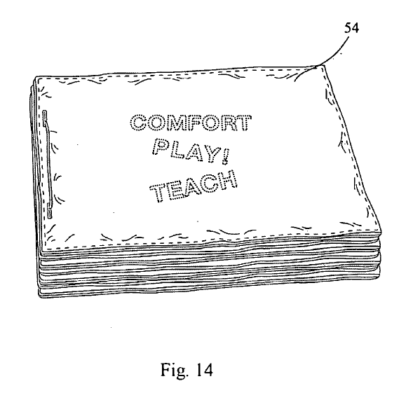

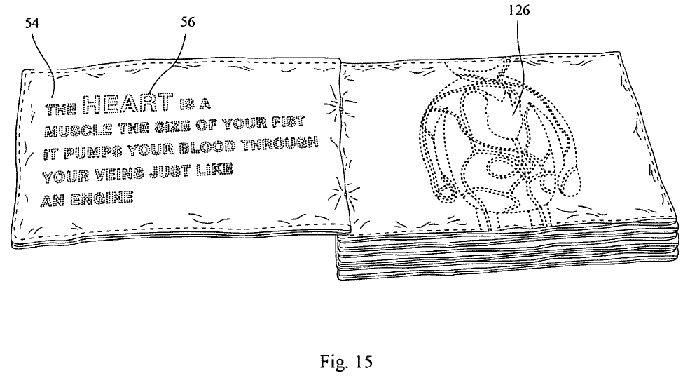

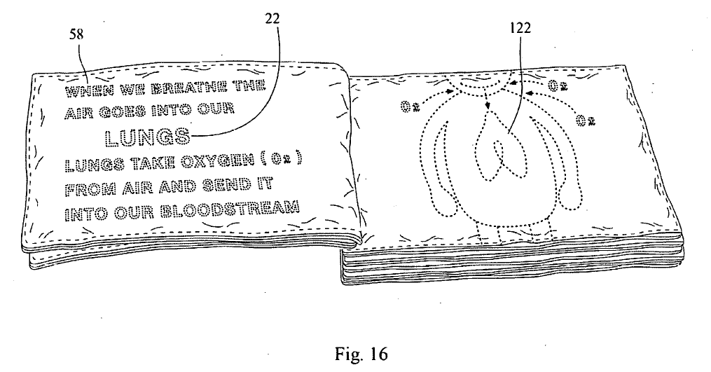

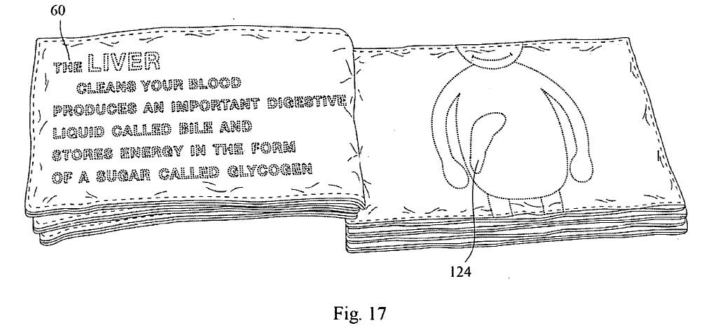

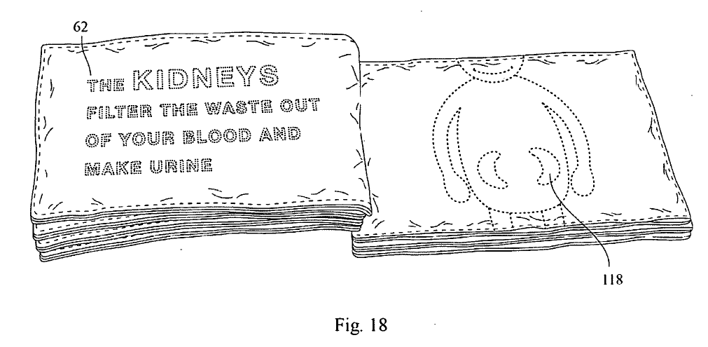

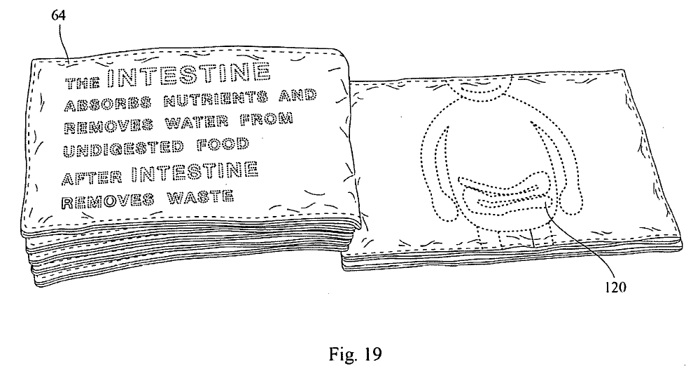

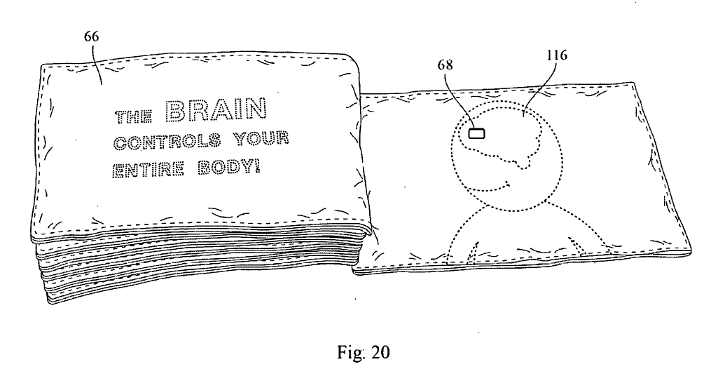

With reference to FIGS. 1-26F, an instructional toy, is provided comprising: a doll (10) having an outside portion (36) and at least one inside portion (e.g. 30, 34 and 52). The doll and the body parts inside may be made of any type of fabric and stuffed with fill material, as in the manner in which stuffed animals are typically made and as would be appreciated by those of skill in the art. As shown in FIGS. 7-8, the flap (28) in a closed position shows the full outside portion (36) and when the flap (28) is opened the portion inside the flap in an inside portion (34). There may also be a zipper (12) which may open and the inside of the dolls head (30) may behold a body part, such as the brain (16), or a zipper (12) around where the mouth of the doll should be may open to reveal an inside portion (52) containing a tongue (32). There is also a book (54) having a related shape (126) of at least one body part (e.g. see FIG. 15, heart (126)) being substantially the same size and shape as the at least one body part (26, the heart removably contained within the doll) and indicia (54) on at least one page of the book related to the at least one body part (26). The body part (26) may be a first color (e.g. red) and the related picture (126) would be the same first color (e.g. red). It may also be useful to have the name of the body part contained in the indicia (see FIG. 15, the word HEART) in the same color. Also, at least a portion of the indicia (again, see FIG. 15, the word HEART) and the related shape (126) may be a tactile fabric corresponding to the at least one body part. In FIG. 15, the indicia (54) says “The Heart is a muscle the size of your fist it pumps your blood through your veins just like an engine.” The tactile fabric, by way of example, may be smooth fabrics such as silk, cotton, wool, jute, flax, or coarse materials such as corduroy, burlap, leather, dimpled leather, dotted swiss, denim, or fine materials such as chiffon, satin, chambray, organdy and felt. There may also be at least one body part of a second color and the related picture is the same second color, as shown in FIG. 16, which depicts the body part of the lungs (22), indicia (58) on at least one page of book is a description of the at least one body part and its function. The second color may be green and the body part (22) from the doll may also be the second color green. The indicia (58) says “When we breathe the air goes into our lungs, lungs take oxygen (O2) from air and send it into our bloodstream.” As shown in FIG. 17, the indicia (60) describes the body part the liver (24) stating “The Liver cleans your blood produces an important digestive liquid called bile and stores energy in the form of a sugar called glycogen”. The related picture (124) shows the liver and the liver in the related picture should be of a similar size and shape (and may be a similar color) as the liver that is removed from the inside of the doll. As shown in FIG. 18, the indicia (62) in the book says “The Kidneys filter the waste of out of your blood and make urine” and the related picture (118) shows the kidneys of a similar size and shape as the kidneys that are removed from the inside of the doll. As shown in FIG. 19, the indicia (64) in the book says “The intestine absorbs nutrients and removes water from undigested food after intestine removes waste” and the related picture (120) shows the intestines. As shown in FIG. 20, the indicia (66) in the book says “The brain controls your entire body!” and the related picture (116) shows the brain as it would appear in the doll or the human body.

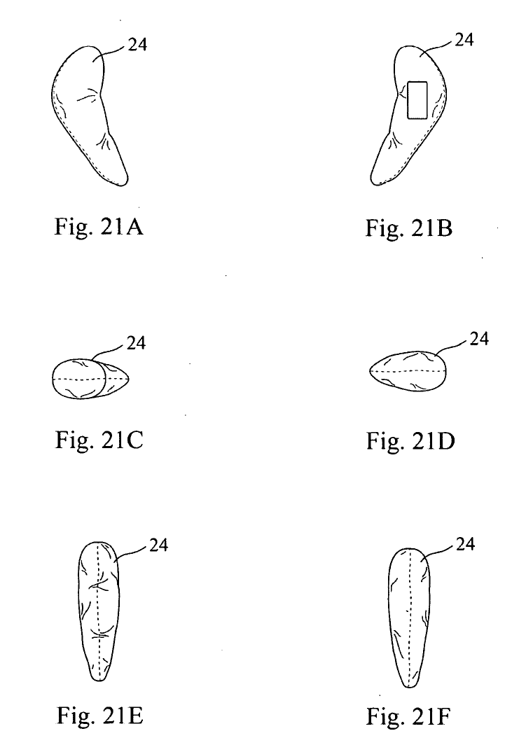

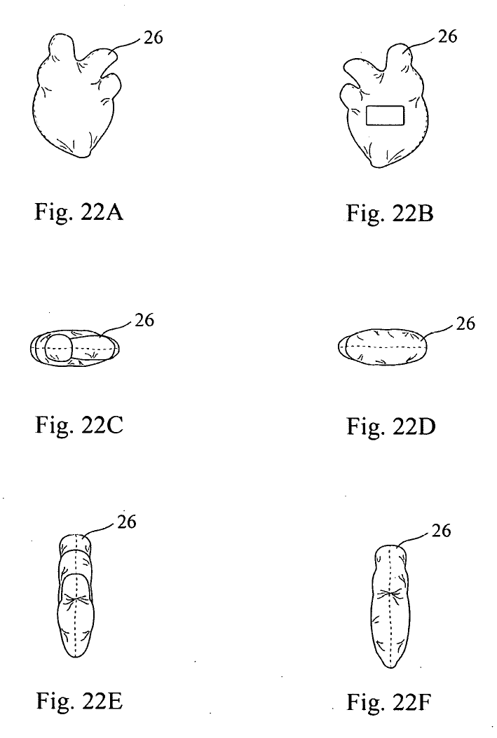

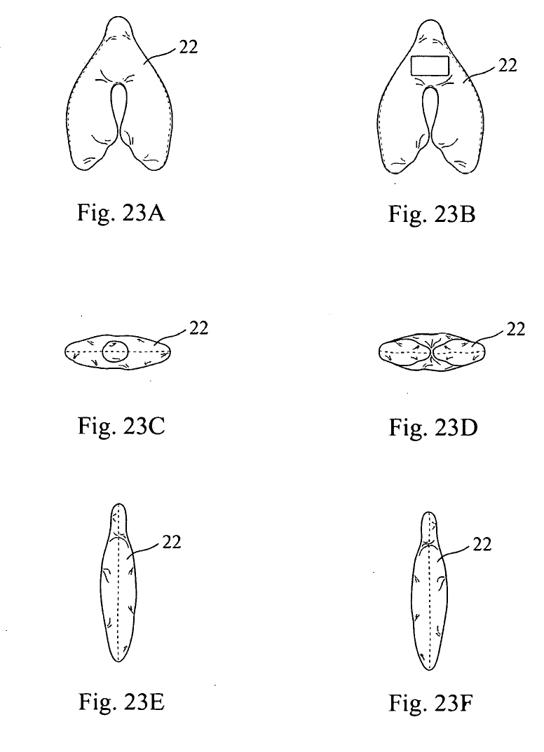

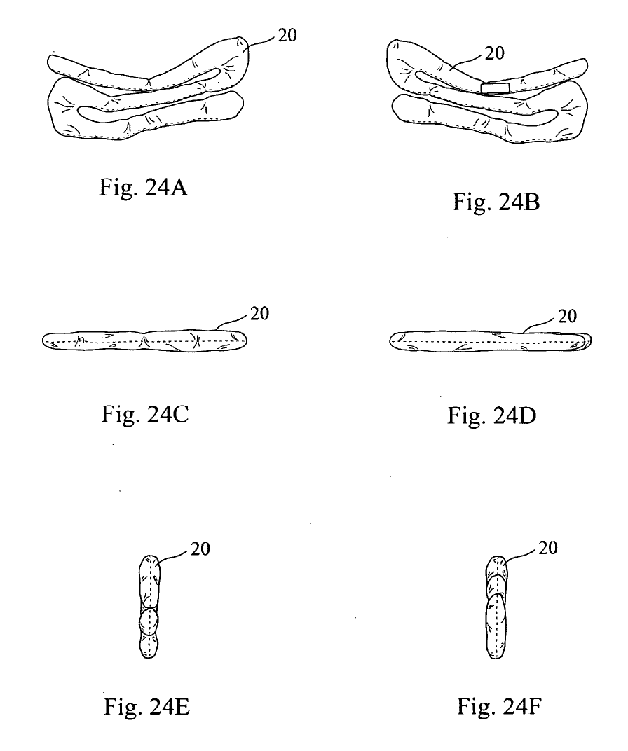

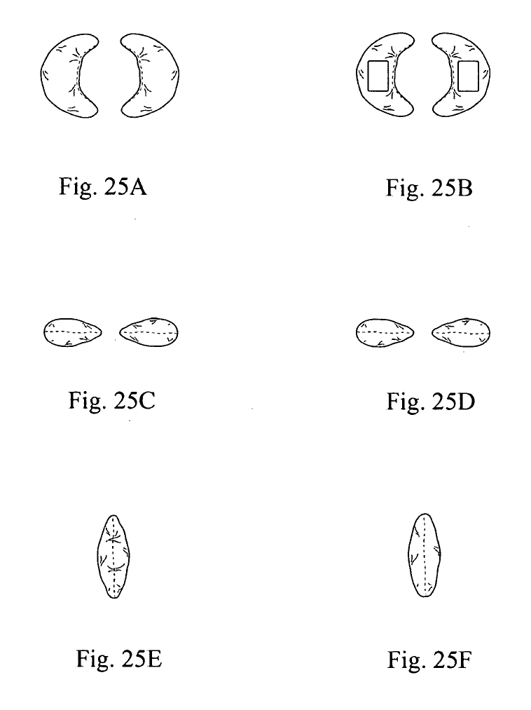

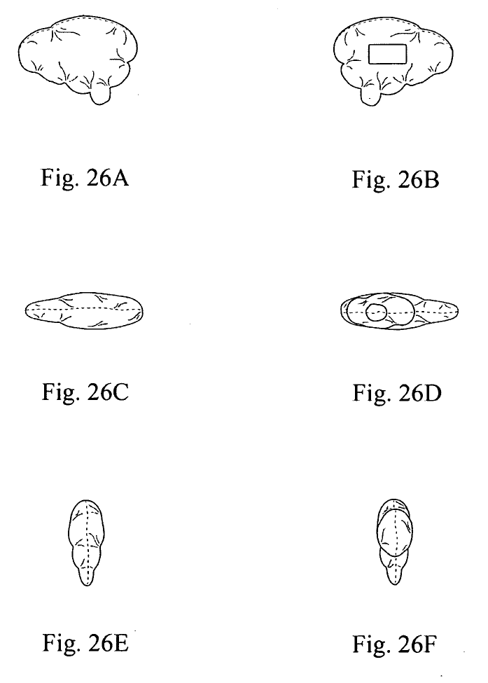

FIGS. 21A-21F depict the liver (24) that would go inside the flap (28) of the doll. As can be seen in FIG. 21B there is a VELCRO® or hook and loop fastening means on both the body part (liver 24) and the inside of the doll (fastening means 38, 40, 42, 46, 48, 50). The liver (24) may be attached to any of the fastening means. FIGS. 22A-22F depict different views of the heart (26) that would go inside the flap (28) of the doll. As can be seen in FIG. 22B there is a VELCRO® or hook and loop fastening means on both the body part (heart 26) and the inside of the doll (fastening means 38, 40, 42, 46, 48, 50). The heart (26) may be attached to any of the fastening means. FIGS. 23A-24F depict different views of the lungs (22) that would go inside the flap (28) of the doll. As can be seen in FIG. 23B there is a VELCRO® or hook and loop fastening means on both the body part (lungs 22) and the inside of the doll (fastening means 38, 40, 42, 46, 48, 50). The lungs (22) may be attached to any of the fastening means. FIGS. 24A-24F depict different views of the intestines (20) that would go inside the flap (28) of the doll. As can be seen in FIG. 24B there is a VELCRO® or hook and loop fastening means on both the body part (intestine 20) and the inside of the doll (fastening means 38, 40, 42, 46, 48, 50). The intestine (20) may be attached to any of the fastening means. FIGS. 25A-25F depict different views of the kidney (18) that would go inside the flap (28) of the doll. As can be seen in FIG. 258 there is a VELCRO® or hook and loop fastening means on both the body part (kidney 18) and the inside of the doll (fastening means 38, 40, 42, 46, 48, 50). The kidney (18) may be attached to any of the fastening means. FIGS. 26A-26F depict different views of the brain (16) that would go inside the flap (28) of the doll. As can be seen in FIG. 26B there is a VELCRO® or hook and loop fastening means on both the body part (brain 16) and the inside of the doll (fastening means 38, 40, 42, 46, 48, 50). The brain (16) may be attached to any of the fastening means. The related shape in the book may also accept the at least one body part by a fastening means. FIG. 20 provides an example of this, showing fastening means (68) for the receipt of brain (16) to related picture (116). As can be seen, the indicia may describe the function of the body part removed from the inside portion of the doll and depicted in the related shape which is in the book and may be shown in the proper anatomical position.

It should be understood that the foregoing relates to preferred embodiments of the invention and that modifications may be made without departing from the spirit and scope of the invention as set forth in the following claims.

I claim:

1. An instructional toy, comprising:
a doll having an outside portion and at least one inside portion, each said at least one inside portion removably containing at least one body part;
a book having a related shape of said at least one body part being substantially the same size and shape as said at least one body part and indicia on at least one page of said book related to said at least one body part.

2. An instructional toy as in claim 1, wherein said at least one body part is a first color and said related picture is the same said first color.

3. An instructional toy as in claim 2, wherein a second at least one body part is a second color and said related picture is the same said second color.

4. An instructional toy as in claim 1, wherein said indicia on at least one page of said book is a description of said at least one body part and it function.

5. An instructional toy as in claim 1, wherein said related shape accepts said at least one body part by a fastening means.

6. An instructional toy as in claim 5, wherein said fastening means is selected from the group consisting of hook and loop fastener and button.

7. An instruction toy as in claim 1, wherein said at least one body part is selected from the group consisting of brain, kidney, intestines, lungs, liver, heart and tongue.

8. An instruction toy as in claim 1, wherein at least one of a portion of said indicia and said related shape is a tactile fabric corresponding to said at least one body part.

9. An instructional toy, comprising:
a doll having an outside portion and at least one inside portion, said at least one inside portion removably containing at least one body part;
a book having at least one related shape of said at least one body part being substantially the same size and shape as said at least one body part and indicia on at least one page of said book related to said at least one body part,
wherein said at least one body part is a first color and said at least one related picture is the same said first color.

10. An instructional toy as in claim 9, wherein a second at least one body part is a second color and a second said related picture is the same said second color.

11. An instructional toy as in claim 9, wherein said indicia on at least one page of said book is a description of said at least one body part and it function.

12. An instructional toy as in claim 9, wherein said related shape accepts said at least one body part by a fastening means.

13. An instructional toy as in claim 9, wherein said fastening means is selected from the group consisting of hook and loop fastener and button.

14. An instruction toy as in claim 9, wherein said at least one body part is selected from the group consisting of brain, kidney, intestines, lungs, liver, heart and tongue.

15. An instruction toy as in claim 9, wherein at least one of said indicia and said related shape is a tactile fabric corresponding to said at least one body part.
